(19) United States
(12) Patent Application Publication
(10) Pub. No.: US 2009/0175590 A1
(43) Pub. Date: Jul. 9, 2009

(54) IPTV REPRODUCING APPARATUS AND DATA REPRODUCING METHOD THEREOF

(76) Inventors: Hee Chang RYU, Pyeongtaek-si (KR); Seung Yong Shin, Pyeongtaek-si (KR)

Correspondence Address: BIRCH STEWART KOLASCH & BIRCH, PO BOX 747, FALLS CHURCH, VA, 22040-0747, US

(21) Appl. No.: 12/349,885

(22) Filed: Jan. 7, 2009

(30) Foreign Application Priority Data
Jan. 8, 2008 (KR) 10-2008-0002265

(51) Int. Cl. H04N 5/00

(52) U.S. Cl. 386/68

(57) ABSTRACT

An IPTV reproducing apparatus and a method for reproducing data are disclosed. A method for reproducing data in an IPTV reproducing apparatus according to the present invention comprises reproducing data associated with a selected program while buffering the data being received through an IP network; and in case of the user's request for multiple speed playback, checking whether a requested multiple speed playback is possible based on a transfer speed of data,

### BACKGROUND OF THE INVENTION

1. Field of the Invention

The present invention has been made in an effort to provide an IPTV reproducing apparatus and a method for reproducing data.

2. Discussion of the Related Art

IP(Internet Protocol) TV is defined as a multimedia service comprising television, video, audio, text, graphic, and data service provided through an IP network where quality, security, and reliability are guaranteed. IPTV also includes a live TV service by using multicasting and a stored video service such as VOD by using unicasting.

An IPTV system comprises a broadcasting server that broadcasts contents (program) to an IP network and an IPTV reproducing apparatus (ex: IPTV set-top box (STB)) that receives contents from an IP network and reproduces the contents. Video and audio signals are encoded according to an encoding method such as MPEG2 or MPEG4 and transferred through an IP network. A live TV service is provided by multicasting according to IGMPv2 protocol, while VOD service is provided by unicasting according to RTSP protocol. An IPTV reproducing apparatus receiving either of the services reproduces the received service, enabling the user to watch video contents.

When network becomes unstable due to a network line problem or rush of users and the amount of data received from a broadcasting server is reduced while an IPTV reproducing apparatus carries out multiple speed playback at the user's request, buffer of the IPTV reproducing apparatus may not contain sufficient data required for subsequent playback. In this case, requested multiple speed playback is not carried out or a playback screen is suspended.

### SUMMARY OF THE INVENTION

The present invention is related to provide an IPTV reproducing apparatus and a data reproducing method therein enabling incessant multiple speed playback even when data transfer rate from a broadcasting server is reduced.

Technical problems to be solved by the present invention are not limited by the aforementioned technical problems. Other technical problems not mentioned but solved by the present invention can be easily recognized from the following description by those skilled in the art to which the present invention belongs.

To achieve the above advantage, a method for reproducing data in an IPTV reproducing apparatus according to the present invention comprises reproducing data associated with a selected program while buffering the data being received through an IP network; and in case of the user's request for multiple speed playback, checking whether a requested multiple speed playback is possible based on a transfer speed of the data.

In the above embodiment, whether the requested multiple speed playback is possible may be checked in real time based on the amount of data input to a buffer for a pre-determined time through the IP network.

In the above embodiment, whether playback with a requested speed is possible may is determined based on the amount of data to be reproduced with respect to the program, the amount of data already buffered but not reproduced yet, and a transfer speed calculated for a pre-determined time.

In the above embodiment, the method may further comprise reproducing data with the requested speed if the requested multiple speed playback is determined to be possible.

In the above embodiment, the method may further comprise, if the requested multiple speed playback is determined to be impossible, receiving an input about whether to carry out playback with optimal speed; and if the playback with optimal speed is requested, determining optimal playback speed based on the amount of data input to a buffer through the IP network for a pre-determined time and reproducing data according to the determined playback speed. Also, the method may further comprise reproducing data with a default playback speed unless the playback with optimal speed is requested.

The optimal playback speed can be determined by further considering the amount of data to be reproduced with respect to the program and the amount of data already buffered but not reproduced yet. In addition, an option for whether to reproduce with optimal playback speed can be displayed on a screen, where the screen can comprise a message indicating impossibility of playback with the requested playback speed and a menu to choose whether to reproduce with optimal playback speed.

An IPTV reproducing apparatus according to another embodiment of the present invention comprises an input unit receiving the selection for a program and request for multiple speed playback from a user; a communication unit configured to receive data associated with the selected program through an IP network; a buffer configured to receive and temporally store the data from the communication unit and to output the stored data; a playback unit configured to decode data output from the buffer and to output the decoded data; and a control unit configured to check possibility of playback with requested playback speed based on a transfer speed of data upon request of multiple speed playback with respect to the program and if the requested multiple speed playback is possible, to control the playback unit to reproduce the program with the requested playback speed.

The present embodiment enables to determine optimal playback speed with respect to network conditions of an IP network, thereby enabling incessant multiple speed playback.

### DESCRIPTION OF DRAWINGS

The accompanying drawings, which are included to provide a further understanding of the invention, illustrate the preferred embodiments of the invention, and together with the description, serve to explain the principles of the present invention.

FIG. 1 illustrates the structure of an IPTV system to which the present invention is applied;

FIG. 2 illustrates a block diagram of an IPTV reproducing apparatus according to the present embodiment;

FIG. 3 illustrates a flow diagram for describing a method for reproducing data in an IPTV reproducing apparatus according to the present embodiment; and

FIG. 4 illustrates an example of a screen for selecting optimal playback speed.

### DETAILED DESCRIPTION OF THE PREFERRED EMBODIMENTS

Hereinafter, preferred embodiments of the present invention will be described in detail with reference to appended drawings.

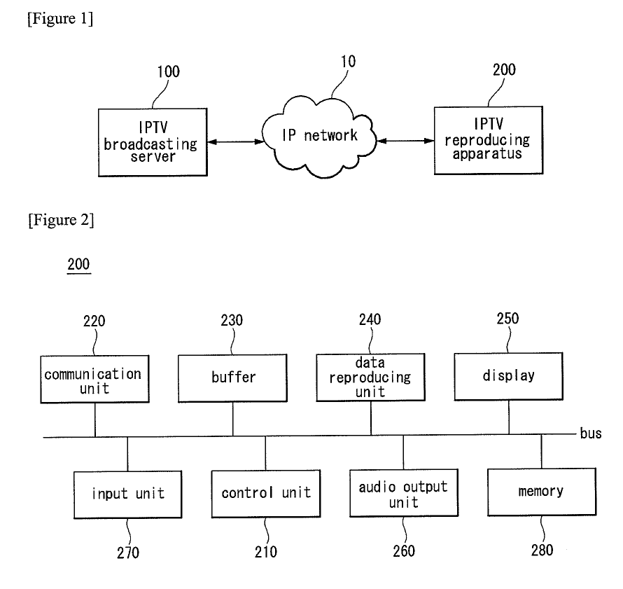

FIG. 1 illustrates the structure of an IPTV system to which the present invention is applied.

Referring to FIG. 1, an IPTV system comprises an IPTV broadcasting server 100 that provides TV broadcasting service through an IP network 10 and an IPTV set-top box 200 that receives and reproduces audio/video data provided from the IPTV broadcasting server 100 through the IP network 10.

An IPTV broadcasting server 100 may comprise a streaming server for providing stored video contents or live contents (TV programs) through an IP network 10, a web server for providing a web service, a CAS/DRM server for protecting contents, an EPG (Electronic Program Guide) server for guiding broadcasting programs, a subscriber management server for managing subscribers, and a billing server for builling. ‘CAS’ is an acronym for Conditional Access System representing contents protection technology that enables only authenticated subscribers to watch corresponding channels of a pay TV system. ‘DRM’ is an acronym for Digital Rights Management representing contents protection technology for preventing illegal copy on the Intenet.

FIG. 2 illustrates a block diagram of an IPTV reproducing apparatus according to the present embodiment.

Referring to FIG. 2, an IPTV reproducing apparatus 200 may comprise a control unit 210, a communication unit 220, a buffer 230, a data reproducing unit 240, a display 250, an audio output unit 260, an input unit 270, and memory 280.

In general, a control unit 210 controls constituting elements of an IPTV reproducing apparatus 200.

More specifically, the control unit 210, upon request for multiple speed playback from the input unit 270, estimates the amount of data input to the buffer 230 and determines whether requested multiple speed playback is possible.

If it is found that playback with the playback speed requested by the user is possible, the control unit 210 controls the data reproducing unit 240 to carry out requested multiple speed playback. On the contrary, if playback with the playback speed requested by the user is found not possible, the control unit 210 so controls that optimal playback speed is displayed on the display 250.

If the user requests playback with optimal speed from an optimal speed playback selection screen through the input unit 270, the control unit 210 determines optimal playback speed based on the amount of data input to the buffer 230 for a pre-determined time through the communication unit 220 and controls the reproducing unit 240 to carry out playback according to the determined optimal playback speed.

The communication unit 220 carries out communication with the IPTV broadcasting server 100 through the IP network 10 by the control of the control unit 210. That is to say, the communication unit 220 requests the IPTV broadcasting server 100 to provide contents or programs requested by the user and receives the corresponding contents or programs from the IPTV broadcasting server 100.

The buffer 230 buffers data associated with contents or programs received through the communication unit 220 from the IPTV broadcasting server 100 and provides the data to the data reproducing unit 240. The data reproducing unit 240 decodes data provided by the buffer 230 and provided the decoded data for the display 250 and the audio output unit 260 under the control of the control unit 210.

The display 250 displays video data decoded and provided by the data reproducing unit 240 and the audio output unit 260 outputs audio data decoded and provided by the data reproducing unit 240. The aforementioned display 250 and audio output unit 260 can also be realized by a separate hardware rather than an IPTV reproducing apparatus 200, for example TV.

The input unit 260 receives a playback request from the user and provides the request for the control unit 210 and can be implemented by key buttons, a touch screen, a remote controller and a receiver of the remote controller, ans so on. In the present embodiment, the input unit 260 receives a request for multiple speed playback or a request for playback with optimal speed and provides the request for the control unit 210.

The memory 270 comprises program memory and data memory. The program memory contains programs for controlling routine operations of the IPTV reproducing apparatus 200 and software programs for carrying out communication with the IPTV broadcasting server 100.

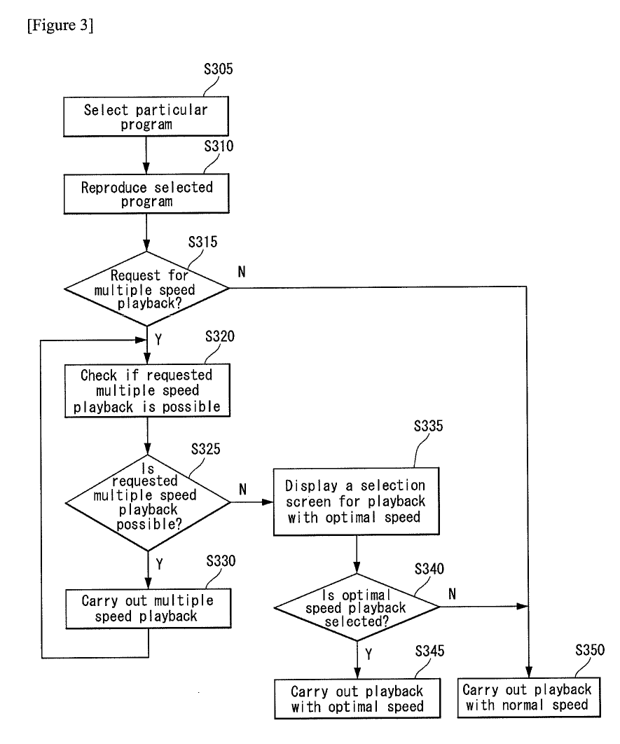

FIG. 3 illustrates a flow diagram for describing a method for reproducing data in an IPTV reproducing apparatus according to the present embodiment.

Referring to FIG. 3, if the user selects a particular program (e.g., channel MBC) through the input unit 270, the input unit 270 provides the control unit 210 with a playback request signal associated with the particular program (S305). The control unit 210, by controlling the communication unit 220, requests the IPTV broadcasting server 100 to provide the particular program requested by the user, receives data associated with the particular program from the IPTV broadcasting server 100, buffers the received data in a buffer 230 and controls the data reproducing unit 240 to reproduce and output the particular program through the display 250 and the audio output unit 260 (S310).

During the playback of the particular program, if the user requests multiple speed playback through the input unit 270 (Yes in S315)—for example, if double speed playback or thriple speed playback is requested—the control unit 210 estimates the amount of data input to the buffer 230 through the communication unit 220 from the IPTV broadcasting server 100 and checks whether the multiple speed playback requested by the user is possible (S320).

For example, it is assumed that at least 10 data per second should be input to the buffer 230 for normal speed playback, at least 20 data per second should be input to a buffer 230 for double speed playback, and the user has requested the double speed playback.

If 15 data per second is input to the buffer in the above mentioned assumption 230, the control unit 210 determines that the double speed playback requested by the user is not possible. On the other hand, if 25 data per second is input to the buffer 230, the control unit 210 determines that the double speed playback requested by the user is possible.

In other words, as described in detail, the contol unit 210, by estimating the amount of data input to the buffer 230 through the communication unit 220 from the IPTV broadcasting server 100, can check whether multiple speed playback requested by the user is possible.

If it is found that reproduction with a playback speed requested by the user is possible (Yes in S325), the control unit 210 controls the data reproducing unit 240 to carry out the multiple speed playback (S330). In this way, while multiple speed playback is being carried out, the control unit 210 returns to S315 step and checks in real time whether current multiple speed playback is possible. This is carried out because current multiple speed playback may not be achievable depending on network conditions.

On the other hand, if requested multiple speed playback is not possible (No in S325), the control unit 210 controls the display 250 to display an optimal playback speed selection screen through an OSD (On Screen Display) generating unit (not shown) by generating the selection screen for the user to select whether to carry out playback with optimal speed (S335). The OSD generating unit can be included in the control unit 210 or in the reproducing unit 240 or installed separately.

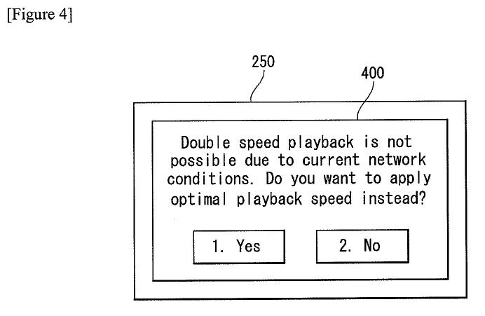

FIG. 4 illustrates an example of a screen for selecting optimal playback speed. Referring to FIG. 4, a screen 400 for selecting optimal playback speed can display guide information such as ‘Double speed playback is not possible due to current network conditions. Do you want to apply optimal playback speed instead?’.

When the user selects playback with optimal speed by choosing ‘YES’ through the key operation of the input unit 270 (Yes in S340), the control unit determines optimal playback speed based on the amount of data input to the buffer 230 for a pre-determined time through the communication unit 220 and controls to carry out playback with optimal speed according to the determined playback speed (S345).

On the other hand, if the user does not select playback with optimal speed by choosing ‘NO’ (No in S340), the control unit 210 controls the data reproducing unit 240 to carry out playback with normal speed. In other words, since playback with a speed requested by the user is not only unachievable due to network conditions but also the user did not request playback with optimal speed, playback with normal speed is carried out. Meanwhile, when checking whether multiple playback speed requested by the user is possible or when determining optimal playback speed, the control unit 210 may further consider not only the amount of data input to the buffer 230 through the communication unit 220 but also the amount of data stored in the buffer after downloading through the communication unit 220.

Since a considerable amount of data is already stored in the buffer 230 while playback of contents is carried out through VOD service and playback time of selected contents is limited, the control unit 210 may determine playback speed to reproduce the remaining amount of a selected contents at a fixed rate, by considering the amount of data to be reproduced afterwards with respect to the selected contents (or remaining playback time), the amount of data already stored in the buffer 230 (or playback time converted from the amount of the stored data), and the amount of data being received through the communication unit 220, namely data transfer speed.

If the amount of data transferred through a communication unit 220 per unit time (transfer speed) is T, the amount of data to be reproduced afterwards with respect to selected contents is R, and the amount of data already stored in the buffer 230 is S, required time for receiving all the remaining data not transferred yet becomes (R−S)/T. At this time, if playback speed requested by the user is V, since playback time for data to be reproduced afterwards becomes R/V, the playback speed requested by the user V should satisfy the condition of R/V>=(R−S)/T, that is, V<=T*R/(R−S).

For example, since if data amount to 20 minutes are left, data amount to 5 minutes are stored in the buffer 230, and data transfer speed is 1.5 times faster than that of data required for normal speed (1×) playback, 1.5*20/(20−5)=2, maximum playback speed to reproduce reminaing data at a fixed rate can be determined to be double speed (2×).

Although descripton of the present invention has beed provided with one embodiment, the present invention is not limited by the foregoing description of a particular preferred embodiment. Thus, those skilled in the art may utilize the invention and various modification of the embodiment can be realized and the modification should fall into the scope of the invention as defined by the following appended claims.

What is claimed is:

1. A method for reproducing data in an IPTV reproducing apparatus, comprising:
selecting a program for viewing;
receiving data through an IP network, the data associated with the selected program;
buffering the data into a buffer while reproducing the data;
receiving a user's request for multiple speed playback; and
determining whether the requested multiple speed playback is possible based on a transfer speed of the data.

2. The method of claim 1, wherein the step of determining comprises:
determining whether the requested multiple speed playback is possible in real time based on an amount of data input to the buffer for a pre-determined time.

3. The method of claim 1, wherein the step of determining comprises:
determining whether the requested multiple speed playback is possible based on an amount of data to be reproduced with respect to the program, an amount of data already buffered but not reproduced yet, and a transfer speed calculated for a pre-determined time.

4. The method of claim 1, further comprising:
reproducing the data with a requested speed if the requested multiple speed playback is determined to be possible.

5. The method of claim 4, further comprising:
receiving the user's input to playback the data at an optimal playback speed if the requested multiple speed playback is determined to be impossible;
determining the optimal playback speed based on an amount of data input to the buffer for a pre-determined time; and
reproducing the data according to the determined optimal playback speed.

6. The method of claim 5, wherein the step of determining the optimal playback speed comprises:
determining the optimal playback speed based on an amount of data to be reproduced with respect to the program and an amount of data already buffered but not reproduced yet.

7. The method of claim 5, further comprising:
reproducing the data with a default playback speed unless playback at an optimal speed is requested.

8. The method of claim 5, further comprising:
displaying on a screen an option for reproducing the data at an optimal playback speed.

9. The method of claim 8, wherein the step of displaying comprises:
displaying a message indicating impossibility of playback with the requested playback speed and a menu to choose whether to reproduce the data at the optimal playback speed.

10. An IPTV reproducing apparatus, comprising:
a display;
an input unit;
a communication unit configured to receive data through an IP network;
a buffer operatively connected to the communication unit and configured to receive and temporally store the data;
a playback unit operatively connected to the the display and the buffer and configured to receive and decode data from the buffer and to output the decoded data to the display; and
a control unit operatively connected to the input unit, communication unit, buffer and playback unit, the control unit configured to cause the IPTV reproducing apparatus to buffer the data into the buffer while reproducing the data, receive a user's request for multiple speed playback from the input unit, and determine whether the requested multiple speed playback is possible based on a transfer speed of the data.

11. The IPTV reproducing apparatus of claim 10, wherein the control unit is configured to determine whether the requested multiple speed playback is possible in real time based on an amount of data input to the buffer for a pre-determined time.

12. The IPTV reproducing apparatus of claim 10, wherein the control unit is configured to determine whether the requested multiple speed playback is possible based on an amount of data to be reproduced with respect to the program, an amount of data already buffered but not reproduced yet, and a transfer speed calculated for a pre-determined time.

13. The IPTV reproducing apparatus of claim 10, wherein the control unit is configured to cause the playback unit to reproduce the data with a requested speed if the requested multiple speed playback is determined to be possible.

14. The IPTV reproducing apparatus of claim 13, wherein the control unit is configured to
receive from the input unit the user's input to playback the data at an optimal playback speed if the requested multiple speed playback is determined to be impossible;
determine the optimal playback speed based on an amount of data input to the buffer for a pre-determined time; and
cause the playback unit to reproduce the data according to the determined optimal playback speed.

15. The IPTV reproducing apparatus of claim 14, wherein the control unit is configured to determine the optimal playback speed based on an amount of data to be reproduced with respect to the program and an amount of data already buffered but not reproduced yet.

16. The IPTV reproducing apparatus of claim 14, wherein the control unit is configured to cause the playback unit to reproduce the data with a default playback speed unless playback at an optimal speed is requested.

17. The method of claim 14, wherein the control unit is configured to display an option for reproducing the data at an optimal playback speed.

18. The IPTV reproducing apparatus of claim 17, wherein the control unit is configured to display a message indicating impossibility of playback with the requested playback speed and a menu to choose whether to reproduce the data at the optimal playback speed.
